(19) United States
(12) Patent Application Publication
(10) Pub. No.: US 2026/0151919 A1
(43) Pub. Date: Jun. 4, 2026

(54) Comfortable user guidance with mobile companion robot

(71) Applicant: Honda Motor Co., Ltd., Tokyo (JP)

(72) Inventors: Tim Puphal, Saitama (JP); Raphael Wenzel, Offenbach (DE); Malte Probst, Offenbach (DE)

(73) Assignee: Honda Motor Co., Ltd., Tokyo (JP)

(21) Appl. No.: 19/357,046

(22) Filed: Oct. 13, 2025

(30) Foreign Application Priority Data
Nov. 29, 2024 (JP) 2024-208454

(51) Int. Cl. B25J 13/06; B25J 5/00

(52) U.S. Cl. CPC B25J 13/06; B25J 5/007

(57) ABSTRACT

A computer-implemented method and system for controlling a mobile robot, which accompanies at least one user, are proposed. The method comprises acquiring information on the at least one user, and predicts a motion intention of the at least one user based on the acquired information. The method acquires information on the physiological condition on the at least one user, determines a user state of the at least one user based on the acquired information on the physiological condition and determines at least one external factor affecting the determined user state. The method proceeds with planning a behavior of the mobile robot that maximizes a user comfort measure determined based on the determined user state and the determined at least on external factor, generates a control signal for controlling the mobile robot that implements the planned behavior, and controls the mobile robot based on the generated control signal.

### CROSS-REFERENCE TO RELATED APPLICATION

This application claims the priority benefit of Japan Patent Application No. 2024-208454, filed on Nov. 29, 2024. The entirety of the above-mentioned patent applications is hereby incorporated by reference and made a part of this specification.

### TECHNICAL FIELD

The invention is in the field of mobile robots and behavior planning for mobile robots. In particular, a computer-implemented method and a system for controlling a mobile companion robot are proposed.

### BACKGROUND

Robotic companions accompany a walking pedestrian and guide the pedestrian to a target position. A mobile robot may accompany a user in a shopping mall or a museum, providing guidance to the user while moving around the environment, and assisting with navigation to specific target positions. Other applications for mobile robots include acting as a partner while exercising.

However, behavior planning for mobile robots in a companion role for a human user currently emphasize targets such as guiding the user to its target in preferably short time. Factors such as comfort of the accompanied user is without concern when planning a future behavior of the mobile robot.

Recent approaches in navigation path planning take external factors, e.g. environmental factors (environmental parameters), into account when planning navigation paths.

CN 115855092 A, for example, discloses an approach for navigation path planning for a person that aims at improving the travel experience of the person by planning a navigation path taking shadow areas on a road into account. The method calculates shadow areas or sun-exposed areas along a road based on elevation and azimuth of the sun and occluding objects such as buildings and trees along the road. Planned navigation path options for the user to reach a destination base on the calculated shadow areas or sun-exposed areas, and may also regard time of the year, e.g. summer or winter, or an ambient temperature while travelling. The recommended navigation path options thereby increase comfort of the user while traveling along a selected navigation path with a high shadow coverage ratio in summer, or a high proportion of sunny path segments in winter, in particular by walking or cycling.

The prior art performs navigation route planning based on external factors, e.g. sun exposure, in addition to the primary target of arriving at a target destination. The user on foot is presented with recommendations for navigation paths that only regard the environmental factor sun exposure, but leave the user to decide which of the recommended options fit his personal needs.

In a different technical field of endeavor, US 2023/0052474 A1 concerns vehicle operation, and correlates a physiological condition of an occupant of the vehicle to an operating parameter of the vehicle. A system monitors physiological parameters of the occupant, detects physiological conditions based on the monitored physiological parameters, determines a correlation of operating parameters of the vehicle to a detected physiological condition, and adapts the operating parameters of the vehicle in order to address the physiological condition. By causing changes to the autonomous operation of the vehicle, which may include modifying a navigation path to a destination, the system intends to avoid negative influence on the physiological condition of the occupant.

There remains the problem of improving the current approaches for behavior planning of mobile robots accompanying users that improve user comfort, which is not considered in current approaches for navigation planning for autonomous agents.

### SUMMARY

The computer-implemented method of independent claim 1, and the system for controlling movement of a mobile robot according to the corresponding independent system claim provide advantageous solutions to the problem.

The dependent claims define further advantageous embodiments.

The computer-implemented method for controlling a mobile robot accompanying at least one user comprises acquiring information on the at least one user, and predicting a motion intention of the user based on the acquired information on the past motion. The method further comprises acquiring information on a physiological condition of the at least one user and determining a user state of the at least one user based on the acquired information on the physiological condition, and determining at least one external factor affecting the determined user state. The method includes planning a behavior of the mobile robot that maximizes a user comfort measure determined based on the determined user state and the determined at least one external factor, and generating a control signal for controlling the mobile robot that implements the planned behavior, and controlling the mobile robot based on the generated control signal.

The mobile robot is a mobile companion robot, e.g. an autonomously operating mobile device that accompanies a user or a group of users that moves in the environment. The mobile robot or robotic companion may act as a museum guide robot, a shopping companion robot or an exercise partner robot for the at least one user when performing physical exercises.

The mobile robot may be one of a micromobility robot, a wheeled robot, a legged robot, a tracked robot, or an airmobile drone or a water drone.

The at least one external factor defines a characteristic in the environment that influences the user state of the human user, the user states of a plurality of users, or a user state of a group of users. The at least one external factor may denote a characteristic of the environment, e.g. an ambient temperature, or of a specific element in the environment, e.g. the number of curves, the radius/radii of the curves of a movement path of the user along a road or a pavement.

The information on the at least one user may include information on a past motion of the at least one user. Motion occurs when an object, in present context the user, changes its position with respect to a reference point when a given time elapses. Motion may be described in terms of displacement, distance, direction, velocity, speed, acceleration, deceleration, rotation, and a frame of reference.

Past motion is motion of the user immediately before and leading up to (until) the current time. The motion intention of the user includes, e.g., an intended trajectory (movement path) of the user. US 2025/0136103 A1 discloses trajectory prediction using a human driver state.

The at least one user is a human user, in particular a walking human user.

The user state (human state of the user) includes, e.g., a human emotional state. Emotional-aware planning for human-robot dialogues is disclosed in EP 4 578 604 A1.

The planned behavior includes a planned trajectory (movement path) of the mobile robot in the environment.

The computer-implemented method provides a framework for planning the behavior of a mobile robot that accompanies a user and that determines and uses external factors as factors in the behavior planning process, which influence the user state, e.g., the emotional state or the physical state of the user accompanied by the mobile robot. The method enables to monitor and deduce the user state of the user, to predict whether the user's intended motion affects the monitored user state, and to plan behaviors of the mobile robot that positively affect the user state of the user.

In an embodiment of the computer-implemented method, the information on the physiological condition includes information on at least one of a pulse rate, heart rate, blood oxygen level, blood pressure and body temperature of the user.

The specific information on the physiological condition is measurable by, e.g., currently widely used wearable sensors and enable to determine a user state of a human user therefrom.

The computer-implemented method according to an embodiment comprises determining the user state further based on image information of a face of the user, or image information of a body shape of the user.

Current mobile robots generally have camera sensors, e.g, for navigation purposes. Processing of image information depicting the user with known processing approaches enables to determine the user state of the user, and thus to acquire the respective information as a basis for adapting the behavior planning for the mobile robot to take the user state into account.

The body shape of the user may have significant influence on which behavior of the user guided by the mobile robot in the environment affects the comfort of the user while executing the behavior. Hence planning the behavior of the robot taking the body shape of the user into account has significant impact on comfort of the user and user state of the user, when guided by the mobile robot.

The computer-implemented method according to an embodiment includes determining the user state based on information on a physiological condition of the user including acquired sensor information from at least one sensor of the mobile robot, in particular from a camera sensor capturing image information depicting the user.

Using the camera sensor of the mobile robot makes efficient use of a sensor already available when implementing the method. Thus, implementation cost is not increased by additional and expensive (camera) hardware.

The at least one sensor may include a wearable sensor worn by the user, e.g. a smartwatch worn by the user.

Wearable sensors are increasingly common and provide a range of different measurements that may advantageously be used for determining the user state of the user. Integration of wearable sensors that generally have a wireless communication interface into a system implementing the method is also cost-effective, as no dedicated and specific sensors need to be designed and added, incurring further hardware cost.

According to an embodiment of the computer-implemented method, the at least one external factor includes at least one of a crowd density, a walking duration, a walking distance, a spatial concentration of a group of users, an ambient temperature, a shadow area in the environment, a sunlit area in the environment, a speed, a number and layout of curves along a movement path.

The cited examples for external factors are currently mostly disregarded in behavior planning for mobile robots for accompanying users, but may significantly influence the experienced comfort of the user when being guided by the mobile robot. Taking these external factors during the behavior planning process into account will increase the acceptance from the side of the user for being accompanied by the mobile robot, due to the increase in concern for the user and thoughtfulness exhibited by the behavior of the mobile robot.

In one embodiment of the computer-implemented method, determining the external factor includes at least one of sensing, by a film capacity rain sensor or by a camera sensor, rainfall or snowfall, sensing, by a temperature sensor, an ambient temperature, determining, by a camera sensor, sunlight intensity, in particular a spatial distribution of sunlight intensity in the environment of the mobile robot, sensing, by a light sensor, glaring light, sensing, by a wind sensor, at least one of a wind direction and wind strength, capturing, by a camera sensor, an image of the surface, and performing, by a processor, image processing on the captured images for determining at least one of a stony surface, rocky surface, a wet surface, a dirty road surface, a road slope, acquiring, from a database stored on a server, at least one of congestion information, a number of visitors for a shop or museum, a waiting time, and acquiring, by a communication unit of the mobile robot, sensor information for determining the at least one external factor.

The cited external factor s are easily measurable and determinable, provide factors, variables or parameters that are quantifiable during the behavior planning process, and significantly influence the quality of the planned behavior when taken into regard in the behavior planning process for the mobile robot.

The computer-implemented method according to an embodiment includes predicting the motion intention of the user. For example, this includes predicting a user trajectory with a constant velocity model based on the acquired information of the at least one user.

Using the constant velocity model offers a computationally efficient approach for predicting the motion intention of the user and enables a cost-efficient implementation of the method when used to predict the intention of the user.

In an embodiment of the computer-implemented method, planning the behavior of the mobile robot includes planning a trajectory for the mobile robot that guides the user on a movement path different from an intended movement path of the predicted motion intention of the user, in case the user comfort measure of the planned trajectory exceeds the user comfort measure of the intended movement path of the motion intention of the user, or planning the trajectory of the mobile robot that guides the user on the intended movement path of the predicted motion intention of the user in case the user comfort measure of the planned trajectory does not exceed the comfort measure of the intended movement trajectory of the predicted motion intention of the user.

Thus, the method plans and controls a behavior of the mobile robot that generally follows the intentions of the user and only acts by guiding the user via the behavior of the mobile robot when the user is determined to fail in maintaining comfort by his own movement intentions. Thus, acceptance from users for a robotic companion controlled by the computer-implemented method can be expected to be high.

In the computer-implemented method according to an embodiment, planning the behavior of the mobile robot comprises determining a discomfort measure based on the determined user state and the at least one external factor, and in case of the determined measure exceeding a threshold, adapting parameters (variables, factors) in a behavior planner according to the determined user state, the predicted motion intention of the user, and the at least one external factor.

Thus, the method plans a behavior of the mobile robot for guiding the user via the executed behavior only when the user is determined to fail in maintaining comfort by his own movement intentions.

In the computer-implemented method according to an embodiment, adapting the parameters of the behavior planner includes at least one of adapting cost components of the total cost function used in the behavior planner, adding behavior options of the mobile robot and adapting weights of the cost components used in the behavior planner.

Adapting the parameters of the behavior planner according to the computer-implemented method enables to integrate the advantageous approach with only limited cost into the present behavior planning and control structure of mobile companion robots.

According to an embodiment of the computer-implemented method planning the behavior of the mobile robot comprises planning the behavior by a cost-based planner, in particular a cooperative risk maps planner, or a search-based planner, e.g., an A* or Monte Carlo tree search based planner, or a sampling-based planner, e.g., a RRT based or probabilistic roadmap-based planner, or a reinforcement learning, e.g., a Q-learning-based or PPO-based planner.

The computer-implemented method may be implemented using a wide range of cost-based behavior-planning algorithms, with only minor modifications by adapting parameters of the employed behavior-planning algorithm, therefore an implementation of the method is cost-effective. For example, the optimization planning algorithms disclosed in patent publications U.S. Pat. No. 11,220,261 B2 and U.S. Pat. No. 11,679,782 B2 form an advantageous base for an implementation of the computer-implemented method.

In the computer-implemented method according to an embodiment, controlling the mobile robot based on the generated control signal includes at least one of controlling, by a controller, movement of the mobile robot, and generating output information based on the planned behavior and outputting the generated output information by a human machine interface of the mobile robot.

The human machine interface may comprise at least one of a voice-based assistance for the user by the mobile robot and a visual output via a display device or a projector of the mobile robot.

The human machine interface may output multiple behavior recommendations via visual output or speech output to the user for selecting one of the recommendations for execution by the mobile robot.

The computer-implemented method therefore makes advantageous use of present modalities for providing guidance by a mobile robot to a human user accompanied by the mobile robot.

The system for controlling a mobile robot configured for accompanying at least one user comprises an acquisition means for acquiring information on the at least one user. The system further comprises a prediction means for predicting a motion intention of the user based on the acquired information on the at least one user, and a user information acquisition means for acquiring information on the physiological condition of the user. The user state determining means of the system is configured to determine a user state based on the acquired information on the physiological condition. The system further comprises a factor determining means for determining at least one external factor affecting the determined user state, and a behavior planner for planning a behavior of the mobile robot that maximizes a user comfort measure determined based on the determined user state and the determined at least one external factor. The system comprises at least one of a controller for generating a control signal that implements the planned behavior, controlling actors of the mobile robot based on the generated control signal, and a human machine interface for generating output information based on the planned behavior of the mobile robot and for outputting the generated output information to the user.

The controller controls the actor of the mobile robot to execute an action to indirectly improve user comfort, e.g., by decelerating movement of the mobile robot, and let user come close. Additionally, or alternatively, the controller controls the actor of the mobile robot to execute an action to directly improve user comfort by executing the movement of the mobile robot along the planned movement path around an obstacle or along a path that is less steep.

### BRIEF DESCRIPTION OF THE DRAWINGS

The following description of embodiments refers to the figures, in which

FIG. 1 shows a schematic flow diagram of a computer-implemented method according to an embodiment;

FIG. 2 presents a simplified block diagram of the system in an embodiment;

FIG. 3 illustrates an application scenario of the computer-implemented method;

FIG. 4 illustrates another application scenario of the computer-implemented method;

FIG. 5 illustrates the external factor crowd density in an application;

FIG. 6 illustrates the external factor splitting of user group in an application;

FIG. 7 illustrates the external factor walking duration in an application;

FIG. 8 illustrates the processing in the behavior planner in a first example of an application;

FIG. 9 illustrates the processing in the behavior planner in a second example of an application;

FIG. 10 presents an overview on a high level of abstraction of a hardware architecture suitable for an implementation of the system.

### DETAILED DESCRIPTION

In the figures, corresponding elements have the same reference signs. The discussion of the figures avoids discussion of same reference signs in different figures wherever considered possible without adversely affecting comprehensibility and avoiding unnecessary repetitions for sake of conciseness.

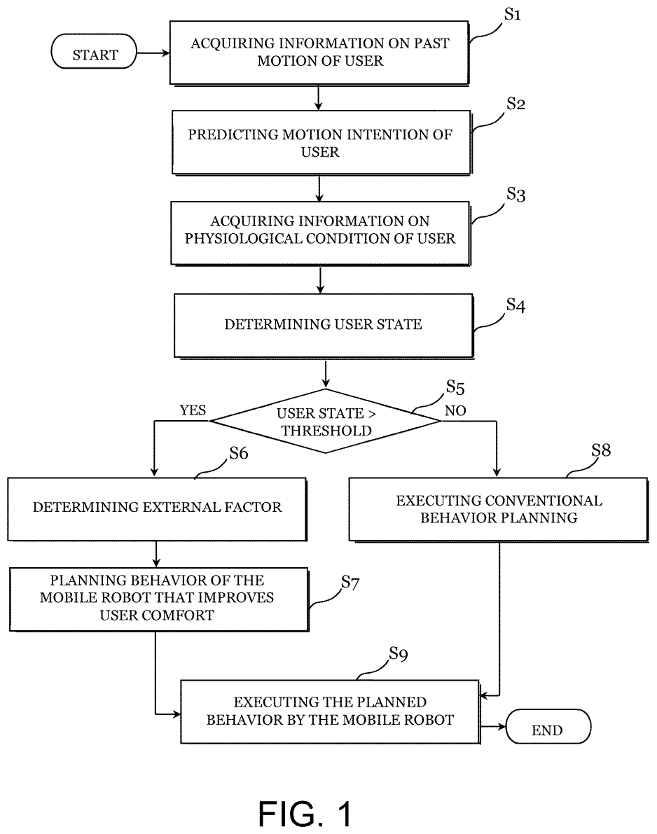

FIG. 1 shows a schematic flow diagram of a computer-implemented method according to an embodiment.

The following embodiment will be discussed with reference to the at least one user 20 being a single user 20 accompanied by the mobile robot 1 except were explicitly stated otherwise.

The information on the at least one user 20 in the following discussion of embodiments is information on the past motion of the at least one user 20.

The method begins with step S1, which includes acquiring information on the past motion of the at least one user 20.

In step S2, the method proceeds with predicting a motion intention 12 of the user 20 based on the acquired information on the past motion of the at least one user 20.

In step S3, the method proceeds with acquiring information on a physiological condition of the user 20. In step S4, the method determines a user state 13 of the user 20 (user state) based on the acquired information on the physiological condition.

In step S9, the method compares the determined user state of the user 20 with a user state threshold. In case the determined user state exceeds the user state threshold, the method proceeds to step S6.

In case the determined user state does not exceed the user state threshold, the method proceeds to step S8.

In step S6, the method determines at least one external factor affecting the determined user state.

The external factor, or external parameter, denotes an external variable that may change over time and whose actual value has an influence on the determination of the user state, in particular which user state is actually determined.

In step S7, which the method executes after step S6, the method plans a behavior 16 of the mobile robot 1 that maximizes a user comfort measure determined based on the determined user state 13 from step S4 and the determined at least one external factor from step S6.

In step S9, the method then proceeds with executing the planned behavior 16.

In step S8, after determining that the determined user state 13 does not exceed the user state threshold, the method executes a conventional behavior planning for determining a behavior of the mobile robot in order to reach a target. After having determined the behavior of mobile robot 1 using conventional behavior planning (conventional behavior) in step S9, the method proceeds from step S8 to step S9 and executes the planned behavior 16, in this case the planned conventional behavior.

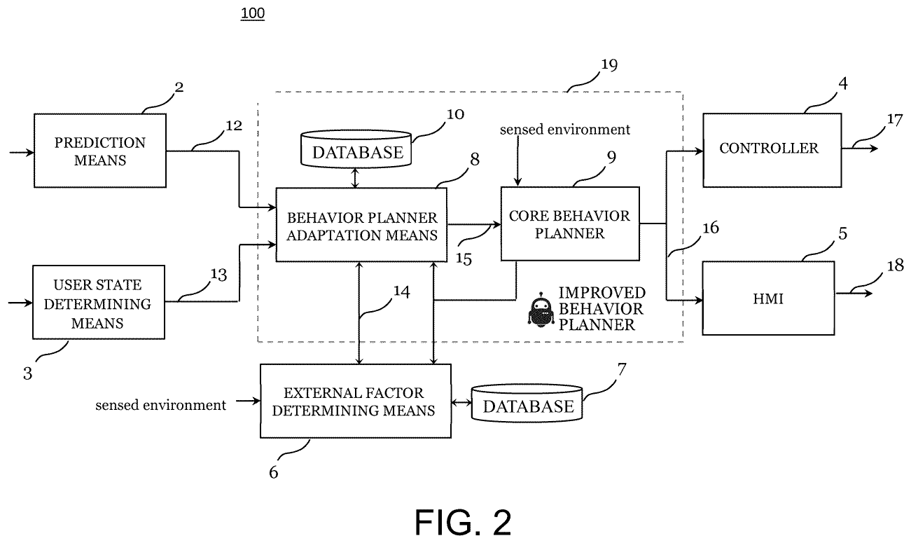

FIG. 2 presents a simplified block diagram that illustrates elements of the system 100 in an embodiment.

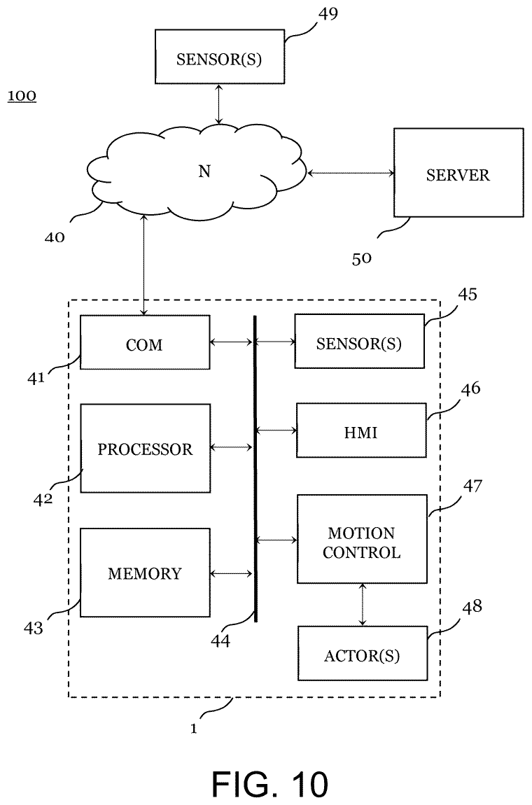

The system 100 is configured to control a mobile robot 1 that accompanies a human user 20 moving around the environment. FIG. 2 shows in particular functional elements, which are suited for implementation in software modules, wherein more aspects concerning hardware implementation of the system are discussed with reference to FIG. 10.

The system 100 for controlling a mobile robot 1 accompanying the user 20 comprises an acquisition means for acquiring information on a past motion of the user 20 not explicitly shown in FIG. 2. The prediction means 2 of the system 100 predicts a motion intention 12 of the user 20 based on the acquired information on a past motion of the user that the acquisition means provides to the prediction means 2.

The predicted motion intention 12 of the user may include, e.g., a predicted user trajectory, which the prediction means 2 predicts based on sensor information included in the information on a past motion of the user 20 using a constant velocity model.

Additionally, or alternatively, the prediction means 2 of the system 100 may predict a motion intention 12 of the user 20 based on acquired information including information on a head angle of the user and a direction of an eye gaze of the user 20 that the acquisition means may acquire, evaluate, and then provide to the prediction means 2.

The acquisition means may acquire the information on the past motion of the user 20 including acquiring, by a communication unit 41 of the mobile robot 1, sensor information from at least one external sensor 49, for predicting the motion intention 12 of the user 20 by the prediction means 2.

The system 100 further comprises a user information acquisition means not explicitly shown in FIG. 2, which acquires information on a physiological condition of the user 20. A user state determining means 3 determines a user state 13 based on the acquired information on the physiological condition of the user acquired by the user information acquisition means and provided to the user state determining means 3 by the user information acquisition means.

The user information acquisition means may acquire the information on a physiological condition of the user from at least one wearable sensor 49 of the user. E.g., the user information acquisition means acquires the user information on the physical condition of the user via a smartphone of the user, or from a smartwatch worn by the user, directly or indirectly via the smartphone of the user.

The smartwatch measures a pulse rate of the user and the user information acquisition means may acquire the information on a physiological condition of the user as pulse rate information from the smartwatch.

Alternatively, or additionally, the user information acquisition means may acquire the information on a physiological condition of the user from one or more sensors 45 of the mobile robot 1. The mobile robot 1 includes a camera sensor attached to its body frame. The camera sensor captures images or sequences of images (video) of the user, depicting in particular the face of the user. Performing suitable image processing on the captured images of facial expressions of the user included in the information on a physiological condition of the user, the user state determining means 3 determines the user state 13 of the user based on the acquired information on a physiological condition of the user including information on the facial expression of the user. The respective facial expression of the user acts as an indicator for a current user state 13, in particular a current emotional state of the user, including, e.g., an angry user state, a sad user state or a happy user state.

Alternatively, or additionally, the user information acquisition means may acquire the information on a physiological condition of the user as camera information from a camera sensor, e.g. the camera sensor attached to the body frame of the mobile robot 1, including image information on the body of the user. The user state determining means 3 then determines the user state 13 including information on the body shape of the user. Information on the body shape of the user provided to the improved behavior planner 19 as discussed below enables to plan behaviors of the mobile robot 1 that include suitable speed values and movement path curve characteristics that may be assumed being convenient to the user.

The user state 13 determined by the user state determining means 3 may include information on at least one of a pulse rate, a heart rate, a blood oxygen level, a blood pressure or body temperature of the user.

The user information acquisition means 6 may acquire the information on the physiological condition of the user including acquiring, by a communication unit 41 of the mobile robot 1, sensor information from the at least one external sensor 49 for determining the user state 13 by the user state determining means 3.

The system 100 further comprises an external factor determining means 6 (a factor determining means 6) for determining at least one external factor 14 affecting the determined user state 13. The factor determining means 6 may acquire the at least one external factor 14 from a database 7 (first database 7), which stores a plurality of predetermined external factors 14 associated with a specific behavior planner and a specific environment.

Otherwise, or additionally, the factor determining means 6 may determine the at least one external factor including information on a crowd density of humans in the environment of the user.

The at least one external factor may include information on a walking duration of the user for reaching particular targets in the environment.

The at least one external factor may include information on a walking distance to a specific target position in the environment.

The at least one external factor may include information on a spatial concentration of a group of users including a plurality of users in the environment. The group of users may be a group of tourists or a group of visitors of a museum, a location of touristic interest, or a shopping mall, for example.

The at least one external factor may include information on an ambient temperature in the environment of the user, or along a planned movement path (movement path option) of the mobile robot 1 together with the user.

The at least one external factor may include information on at least one shadow area in the environment, or at least one area exposed to the sun in the environment. The factor determining means 6 determines the information on the at least one shadow area or on the at least one area exposed to the sun in the environment or along a movement path option of the mobile robot 1 based on time of the year, time of the day, weather data including current weather data and weather forecast data, and information on physical objects including object size and object position.

The at least one external factor may include information on a speed, a number and a layout of curves along a movement path option.

The factor determining means 6 may obtain spatial information on movement path options from a core behavior planner 9 of the improved behavior planner 19 as indicated in FIG. 2.

The factor determining means 6 may determine the external factor by sensing, e.g. using a film capacity rain sensor or using a camera sensor, rainfall or snowfall.

The factor determining means 6 may determine the external factor by sensing, e.g. using a temperature sensor, an ambient temperature in the environment.

The factor determining means 6 may determine the external factor by measuring, e.g. using a camera sensor, sunlight intensity, in particular a spatial distribution of sunlight intensity in the environment of the mobile robot 1.

The factor determining means 6 may determine the external factor by sensing, e.g. using a light sensor, glaring light, which is light with an incidence direction and a light intensity (brightness) that has the capability to blind the user 20 when following a movement path of the mobile robot 1.

The factor determining means 6 may determine the external factor by sensing, e.g. using a wind sensor, at least one of a wind direction and wind strength in the environment or along a planned movement path option of the mobile robot 1.

The factor determining means 6 may determine the external factor by capturing, e.g., using a camera sensor, an image of the surface, and performing, by a processor, image processing on the captured images for determining at least one of a stony surface, rocky surface, a wet surface, a dirty road surface, a road slope.

The factor determining means 6 may determine the external factor by acquiring, e.g. from a database 7 stored on a server 50, at least one of congestion information, a number of visitors for a shop, museum, a shopping mall, a store, and a waiting time for a shop, museum, a shopping mall, a store, or a point of touristic interest.

The factor determining means 6 may determine the external factor by acquiring, e.g. using a communication unit 41 of the mobile robot 1, sensor information from the at least one external sensor 49 for determining the at least one external factor.

The system 100 includes a behavior planner 19 (improved behavior planner 19), which comprises a behavior planner adaptation means 8 and a core behavior planner 9.

The system 100 further includes a database 10 (second database 10). Alternatively, or additionally, the behavior planner adaptation means 8 has access to a database externally to the behavior planner 19, which corresponds to the database 10.

The improved behavior planner 9 plans a behavior 16 of the mobile robot 100 that maximizes a user comfort measure that is determined based on the determined user state 13, the predicted motion intention 12 of the user 20 and the determined at least one external factor 14.

The behavior 16 may include a behavior plan, which includes at least one of a planned movement path (planned trajectory) for the mobile robot 1, and a communication plan including a communication of information to the user 20 via a human machine interface 5.

In particular, the behavior planner adaptation means 8 adapts components of the behavior planner 9 according to the user state 13, the motion intention of the user 20, and the external factors 14.

The behavior planner adaptation means 8 detects a discomfort of the user 20 based on the user state 13. In a specific application example, the behavior planner adaptation means 8 determines the heart rate of the user 20 exceeding a heart rate threshold based on the user state 13, and further determines the external factors 14 to include a high ambient temperature and detects the existence of shadow areas along a motion direction corresponding to the motion intention 12 of the user 20.

The behavior planner adaptation means 8 adds a comfort cost component, e.g. for following shadow areas based on thresholds and rules obtained from the database 7.

The behavior planner adaptation means 8 may determine whether the predicted motion intention 12 improves comfort of the user 20 on its own, and, in case of determining that the motion intention 12 fails to improve the comfort measure determined for the user 20, provide additional behavior options for the mobile robot 1 to the core behavior planner 9. The core behavior planner may then proceed to plan a behavior of the mobile robot 1 that guides the user 20 along shadow areas in the environment towards the direction of the predicted motion intention of the user 20.

The behavior planner adaptation means 8 may determine the added comfort cost component weight, e.g., the shadow comfort weight by a calculation, based on the user state 13, or based on a tracked negotiation strength between a comfort guidance action executed by the mobile robot 1, and the corresponding reaction of the user 20.

The behavior planner adaptation means 8 may adapt parameters of the core behavior planner 9 using a state machine or a behavior tree. In order to give a specific example, a first task may correspond to the user 20 reaching a particular goal, while a second task bases on a switch setting refers to improving the user state 13 by going to a shadow area, and then addressing the first task again of reaching the goal.

Alternatively, the behavior planner adaptation means 8 retrieves a relationship between the user state 13 and the external factor 14 and corresponding parameter adaptation proposals for the core behavior planner 9 by prompting a large language model.

The behavior planner adaptation means 8 provides the determined cost components, behaviors, and weights to the core behavior planner 9 for planning the behavior 16 of the mobile robot 1. In the example of the user 20 being guided towards a target in an environment of high temperatures that exceed a comfort temperature level of the user 20, the behavior planner adaptation means 8 provides a shadow comfort benefit cost component, a user target speed cost component, a behavior option “wait in a shadow area” as well as a behavior option “rest at coffee shop” to the core behavior planner 9.

Based on the determined cost components, behaviors and weights provided to the core behavior planner 9 as adapted planning parameters 15, the core behavior planner 9 plans the behavior 16 of the mobile robot 1.

In the specific example, the behavior planner 9 plans the behavior of the mobile robot 1 that includes a movement trajectory that runs within shadow areas in the environment, while simultaneously guaranteeing the conditions of avoiding static and dynamic objects in the environment and reaching the target of the user 20 indicated in the predicted motion intention 12. For planning the behavior of the mobile robot 1, the core behavior planner 9 further uses sensor information on the environment of the mobile robot 1 obtained via sensors 45 of the mobile robot 1. Alternatively, or additionally, the mobile robot 1 uses sensor information on the environment acquired via a communication interface 41 from sensors 49 external to the mobile robot 1.

The core behavior planner 9 is implemented as a cost-based planner for planning behaviors of autonomously operating agents. In an example, the core behavior planner 9 may be implemented using a cooperative risk maps planner, e.g. as discussed in detail in patent publications U.S. Pat. No. 11,220,261 B2 and U.S. Pat. No. 11,679,782 B2.

Alternative implementations of the core behavior planner 9 use different cost-based planning algorithms, e.g., a search-based planner, e.g., an A* or Monte Carlo tree search based planner, or a sampling-based planner, e.g., a RRT based or probabilistic roadmap-based planner, or a reinforcement learning, e.g., a Q-learning-based or PPO-based planner.

The system 100 further includes at least one of a controller 4 and a human machine interface 5.

The controller 4 generates a control signal 17 that implements the planned behavior 16 provided by the behavior planner 9. The controller 4 outputs the generated control signal 17 to actors 48 of the mobile robot 1 and controls the actors 48 of the mobile robot 1 via the generated control signal 17.

The actors 48 implement the planned movement of the mobile robot 1 based on the control signal 17. For example, the actors 4 include legs of a humanoid mobile robot 1, which are actuated based on the control signal 17 to move the mobile robot 1 along the planned movement path in the environment, e.g. guiding the user 20 along the planned trajectory of the mobile robot 1. In a specific example, the system 100 controls the actors 4 of the mobile robot 1 to brake and to decrease speed of the mobile robot 1 to allow the user 20 to come close to the mobile robot 1 in order to be able to provide close guidance around an object in the predicted movement path of the user 20, or to change motion direction of the moving mobile robot 1 in order to guide the user 20 around the obstacle on a movement path that has an advantageously small inclination.

The human machine interface 5 generates an output signal 18 including output information based on the planned behavior 16 of the mobile robot 1 provided by the improved behavior planner 9, and outputs the output signal to an output means, e.g. a display, one or more loudspeakers or a headphone worn by the user 20. The output means communicates the output information via acoustic, visual, or haptic signals or a combination of such signals to the user 20.

The human machine interface 5 may output information comprising recommendations for behavior options for the mobile robot 1 and the user 20 accompanied by the mobile robot 1 to the user. In a specific example, the system 100 controls the user interface 5 of the mobile robot 1 to provide voice assistance to the user 20, e.g., by outputting via a loudspeaker “look here to the right, do we want to walk under the shadows” in order to guide the user 20 to walk in the shadows, thereby increasing the comfort of the user 20 in light of an environment characterized by high temperatures and a high sensitivity of the user 20 to high temperatures.

In the same specific example, the system 100 controls the user interface 5 of the mobile robot 1 to provide visual assistance to the user 20, e.g., by outputting via a display a message “shadow is better” in order to guide the user to walking in the shadows, thereby increasing the comfort of the user 20 in the environment characterized by high temperatures and the high sensitivity of the user 20 to high temperatures.

Additionally, or alternatively, the human machine interface 5 may output information visually or acoustically to the user 20 comprising multiple different recommendations for behavior options for the mobile robot 1 and the user 20 accompanied by the mobile robot 1. In the same specific example, the system 100 controls the user interface 5 of the mobile robot 1 to provide visual assistance to the user 20, e.g., by outputting information to the user 20 including the alternative options in a message “We may wait in the shadows close to the building, or proceed further with a reduced walking speed”.

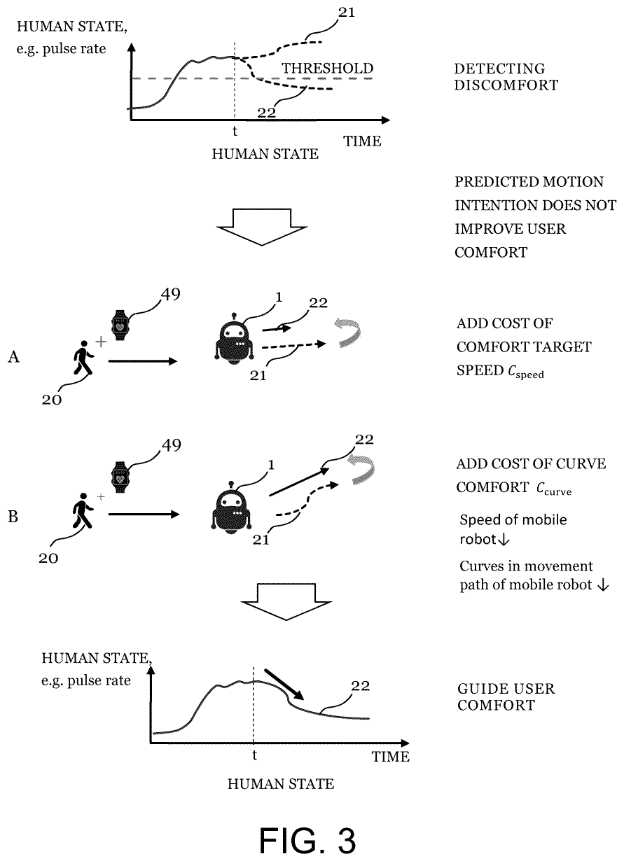

FIG. 3 illustrates an application scenario of the computer-implemented method. The application scenario includes the mobile robot 1 acting as a companion robot that accompanies a human user 20, while walking in the environment. In particular, the mobile robot 1 guides the user 20, which essentially means that the user 20 follows the movement path on which the mobile robot 1 moves in the environment. Thus, the mobile robot 1 directs the user 20.

The system 100 according to the embodiment discussed with reference to FIGS. 1 and 2 plans and controls the behavior executed by the mobile robot 1. Thus, the system 100 determines and influences the user state 13 of the user 20 by determining external factors 14. The system 100 determines whether the predicted motion intention of the user 20 improves a determined comfort measure of the user 20. If the predicted motion intention of the user 20 has the capability to improve the determined comfort measure of the user 20, then the system 100 performs behavior planning for the mobile robot 1 in a known and conventional manner, in particular without adapting the parameters of the behavior planner 19 by the behavior planner adaptation means 8.

The upper part of FIG. 3 illustrates the user state 13 over time. At a current time t, the user state 13, e.g., including a pulse value of the user 20 exceeded a threshold already for some time. The system 100 predicts a motion intention 12 of the user 20 that does improve the user comfort as illustrated by the continuation curve 22 of the user state 13 for times from time t onwards.

Alternatively, the system 100 predicts a motion intention 12 of the user 20 that does not improve the user comfort as illustrated by the continuation curve 21 of the user state 13 for times from time t onwards.

If the predicted motion intention of the user 20 fails to improve the determined comfort measure of the user 20, then the system 100 performs the behavior planning for the mobile robot 1 according to the illustrated procedure of the center portion of FIG. 3.

The system 100, in particular the behavior planner adaptation means 8 then adapts parameters of the behavior planner 19.

For example according to FIG. 3, the system 100 adds a cost of comfort target speed cspeed to the cost in the behavior planner 19.

Additionally, the system 100 adds cost of curve comfort C_{curve} to the cost in the behavior planner 19.

The behavior planner 19 plans a behavior of the mobile robot 1 with the adapted cost in the cost-based behavior planning process in the core behavior planner 9. Due to the adapted cost including the cost C_{speed} the planned behavior of the mobile robot 1 will have a reduced speed of the mobile robot 1 when compared to the result of a behavior planning process that does not include the adapted cost, thus without regarding the adapted cost including the cost component C_{speed}. This is illustrated in partial view A in the center portion of FIG. 3.

Due to the adapted cost including the cost C_{curve}, the planned behavior of the mobile robot 1 will have a straightened movement trajectory of the mobile robot 1 with less curves when compared to the result a behavior planning process that does not include the adapted cost, hence without regarding the adapted cost including the cost component C_{curve}. This is illustrated in partial view B in the center portion of FIG. 3.

As illustrated in the lower portion of FIG. 3, the improved behavior planning process performed by the system 100 enables to control the movement of the mobile robot 1 such that the system 100 guides the user comfort of the user 20, in particular reducing the pulse rate of the user 20 following the movement of the mobile robot 1 to low values, in particular low values of the pulse rate as indicated by curve 22. The values of the curve 22 of the pulse rate are below the threshold level for the pulse rate, and smaller than the values of the curve 21 of the pulse rate when not adapting the cost of the behavior planning in the behavior planner 19.

Contrary to the processing in the system 100, and the computer-implemented method of FIG. 1, the known approaches for behavior planning in autonomous devices acting as robotic companions fail to consider the user state 13 of the user 20. The system 100, however, considers human motion intention 12, in combination with external factors 14 that influence the comfort of the user 20 as defined in a user comfort measure for the behavior planning process for the mobile robot 1.

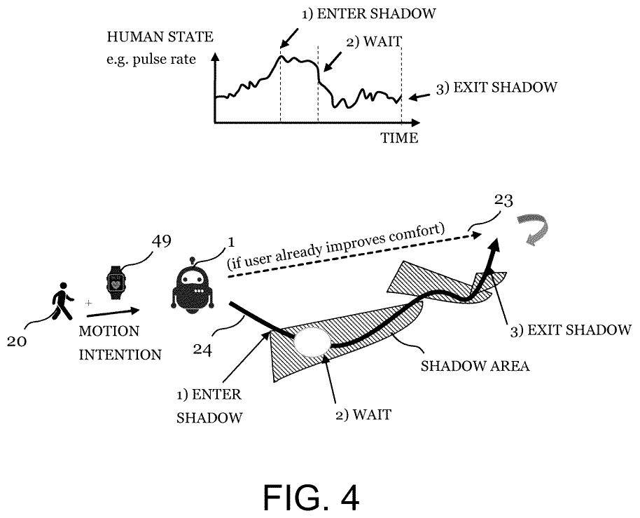

FIG. 4 illustrates another application scenario of the computer-implemented method. The application scenario includes the user 20 walking together with the mobile robot 1 that is controlled by the system 100 in an environment in an ambient temperature that exceeds the temperature of the human user generally accepted as comfortable, e.g. the ambient temperature is more than a temperature range of 25° C. or 30° C. for giving specific examples.

The ambient temperature represents an example for an external factor that affects the comfort of the user 20 when walking guided by the mobile robot 1 along a movement path in the environment. Furthermore, the environment includes shadow areas and therefore regions in which the exposure to the sun is reduced when compared to regions in which the sun directly shines on the mobile robot 1 and the user 20 accompanying the mobile robot 1.

The system 100 determines the user state 13 of the user 20 and senses a high heart rate of the user 20, e.g. a heart rate that exceeds a comfort level of a human, thereby indicating a feeling of discomfort of the user 20 as the user state 13. The system 100 associates the determined user state 13 of discomfort, including a high heart rate with the high temperature measured in the environment.

The system 100 determines the external factor ambient temperature and detects shadow areas in the environment, extending near the intended movement path 23 of the user 20 accompanied by the mobile robot 1.

If the system 100 determines that the user 20 improves the comfort measure by executing the motion intention 12 and moving along the movement path 23 in the lower path shown in the figure, the system 100 performs behavior planning without adapting the parameters of the behavior planning process in the behavior planner 19. The mobile robot will move along the movement path 23 as indicated in the lower portion of FIG. 4.

The human comfort measure, in particular a shadow comfort benefit C_{shadow} of the user 20 following the mobile robot 1 depends on the time the mobile robot is driving in the shadow and shielded from a direct exposure to the sun. The total cost to be regarded in the improved behavior planner 19 then, e.g., comprise a collision risk R_{collision} regarding collisions with static and dynamic objects in the environment, a utility to reach a goal U_{goal} regarding the motion intention of the user 20, and the shadow comfort benefit C_{shadow} determined by the behavior planner adaptation means 8. Each cost component R_{collision}; U_{goal}, and C_{shadow} is taken into account with a corresponding cost weight W_{collision}, W_{goal} and W_{shadow}, resulting in a total adapted cost function Cₜₒₜₐₗ of

$${C}_{total} = {w}_{collision} {R}_{collision} - {w}_{goal} {U}_{goal} - {w}_{shadow} {C}_{shadow} \qquad ( 1 )$$

The system 100 performs behavior planning for the mobile robot 1 based on the cost function according to expression (1), resulting in a behavior including a movement path 24 exploiting the benefit of the user 20 moving along the shadow areas in order to approach the target of the motion intention 12 following the mobile robot 1.

The system 100 controls the mobile robot 100 moving along the movement path 24 with a continuously changing cost component of shadow comfort benefit C_{shadow} due to a shadow comfort weight W_{shadow} continuously changed according to the motion intention of the user 20 by the behavior planner adaptation means 8. The improved behavior planner 19 plans the behavior of the mobile robot 1 along the shadow areas from a time 1) when entering a first shadow area to a time 3) when exiting the third shadow area in the environment depicted in the lower part of FIG. 4 while moving along the target.

The system 100 may also plan an additional behavior for the mobile robot 1, depending on the determined human intention 12. In case the determined human intention 12 allows, the system 100 determines to add an additional waiting behavior for the mobile robot 1 at a time 2) in the first shadow area, thereby achieving a further advantageous reduction in the pulse rate of the user state 13 while being static in the shadow area as indicated in the upper portion of FIG. 4.

Generally, the planned movement path of the mobile robot 1 path follows the determined motion intention 12 of the user 20. The prediction means 2 may predict the motion intention 12 of the user 20 using a constant velocity model. The utility benefit U_{goal} included in the total cost Cₜₒₜₐₗ ensures that the movement path of the planned behavior 16 enables the mobile robot 1 to reach the target (goal point) of the user trajectory of the predicted motion intention 12 of the user 20. If the predicted motion intention 12 fails to improve the user comfort measure on its own, the system 100 plans the behavior of the mobile robot 1 with the improved behavior planner 19 using the added cost components, e.g. including the added cost component for a shadow comfort benefit.

The behavior planner adaptation means 8 determines a weight of the cost component shadow comfort benefit in dependence on a difference between a needed comfort C_{target} required by the user 20 and an estimated user comfort Cᵤₛₑᵣ according to expression (2)

$${w}_{shadow} \sim Δ C = {C}_{target} - {C}_{users} ; \qquad ( 2 )$$

The required C_{target} are determined by the determined current user state 13, e.g., by the pulse rate. The estimated user comfort Cᵤₛₑᵣ is estimated based on the determined current motion intention 12 of the user 20.

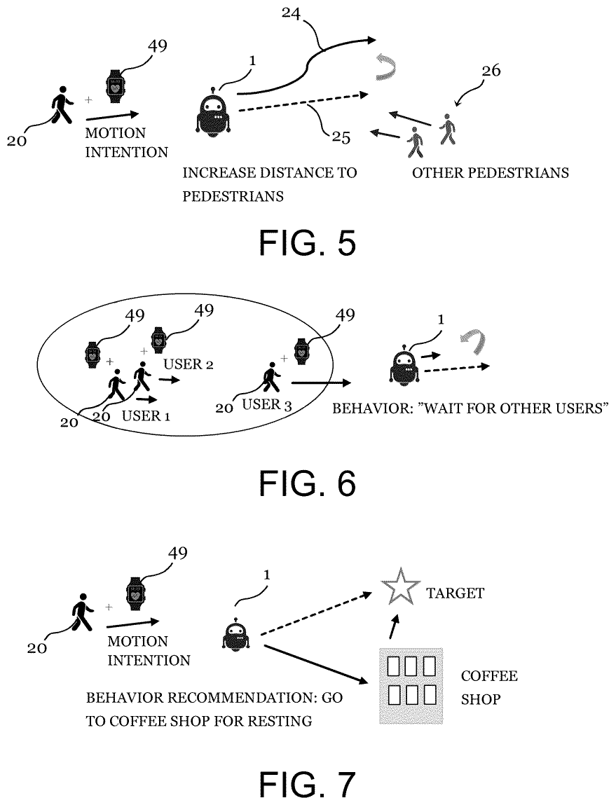

FIG. 5 illustrates the external factor crowd density in an application.

The scenario of FIG. 5 concerns the user 20, which is accompanied by the mobile robot 1. The system 100 predicts the motion intention 12 of the user 20 to include an intended movement path 25. The intended movement path 25 passes near a group of other pedestrians 26.

In the example of FIG. 5, the external factor 14 is a crowd density. A stress level of the user 20 is dependent on a distance to other human persons. The stress level will increase with a decreasing distance to the other pedestrians 26.

The system 100 determines a comfort measure for the user 20 based on an estimated stress level of the user 20, which may be determined by the system 100 using sensors 49 attached to the user 20, e.g., a heart rate sensor, a blood oxygen sensor, a blood pressure sensor, a body temperature sensor in order to cite some examples.

The system 100 determines a high crowd density as an external factor 14 affecting the user state 13 in the environment, e.g. a pedestrian walk area, which the predicted movement path 25 will pass at a short distance. The system 100 may determine the crowd density based on signals from a camera sensor of the mobile robot 1 accompanying the user 20.

If the system 100 determines a user state 13, which includes a high stress level of the user 20, and also predicts the movement path 25 to fail to keep distance to the group of other pedestrians 26, the system 100 adapts the total cost function of the behavior planner 19 for planning the behavior 16 of the mobile robot by adding an additional cost component (peripersonal cost component) to the cost. The behavior planner 19 then plans a behavior of the mobile robot 1 that includes a planned movement path 24 that will yield an increased distance to the group of other pedestrians 26, when compared with the predicted intended movement path 25. The system 100 controlling the movement of the mobile robot 1 on the planned movement path 24 guides the user 20 to a behavior that will ultimately improve the user state 13 by avoiding an increase in the stress level due to small distances to the other pedestrians 26.

FIG. 6 illustrates the external factor “splitting of user group” in an application scenario.

The external factor 14 affecting the user state 13 of each user 20 in a group of users 20 may include a potential splitting of the group of users 20. A characteristic of groups of users is that the users 20 being part of the group intend to stay together when following the mobile robot 1 as a group of users 20. A scenario in which this behavior of the users 20 may be used in behavior planning for the mobile robot 1 by the system 100 is a mobile tour guide robot guiding a group of tourists including user 1, user 2, and user 3 in the scenario of FIG. 6.

The system 100 estimates a stress level of each individual user, and determines the user state 13 of each user 20 of the group of users 20 based on the estimated stress level.

The external factor 14 is the splitting of the group of users 20. The mobile robot 1 may detect a splitting of the group by monitoring the group with its camera sensor. The system 100 may determine the external factor 14 by evaluating information provided by the camera sensor of the mobile robot 1.

If the system 100 determines a high stress level for some users 20 of the group of users 20, and predicts that the users 20 of the group of users 20 do not intend to wait for each other, the system 100 adapts the behavior planning in the improved behavior planner 19. The behavior planning adaptation means 8 activates a behavior, which includes “wait for all users 20 by stopping at safe area”, and the improved behavior planner 19 takes the added behavior option into account when planning the behavior 16 of the mobile robot 1.

The behavior planning adaptation means 8 may also activate a behavior, which includes “reduce speed until group users 20 close”. The improved behavior planner 19 then takes the added behavior options into account when planning the behavior 16 of the mobile robot 1.

FIG. 7 illustrates the external factor 14 walking duration in an application.

The user 20 accompanied of the mobile robot 1 may be determined to be in a tired user state 13 from a long walk and have the intention to rest before resuming his walk again.

The system 100 determines the user state 13 “tired user state” based on a sensed pulse rate of the user 20 and by measuring the external factor 14 as a time duration of the walk, or the distance covered by the walk.

The system 100 may identify additional behavior options for adapting the behavior planning process for the mobile robot 1 by identifying suitable venues for resting in a vicinity of the user 20 and the mobile robot 1. In the example depicted in FIG. 7, the system identifies a coffee shop in a short walking distance from the current location, and on the way to the target of the walk.

The system 100 monitors the user state 13 of the user 20, e.g. the pulse rate measured by a smartwatch worn by the user 20. In case the system 100 determines the pulse rate to exceed a predetermined pulse rate threshold, and the determined motion intention 12 of the user 20 does not indicate that the user 20 wants to rest, the system 100 adapts parameters of the behavior planning process in the improved behavior planner 19, and activates an additional behavior for planning the movement path of the mobile robot 1. The additional behavior for the behavior planning includes the mobile robot 1 moving from the current location of the mobile robot 1 with the user 20 to the identified resting venue, e.g. the coffee shop in the example of FIG. 7. The additional behavior for the behavior planning includes the mobile robot 1 recommending to the user 20 via the human machine interface 5 to go to the identified resting venue.

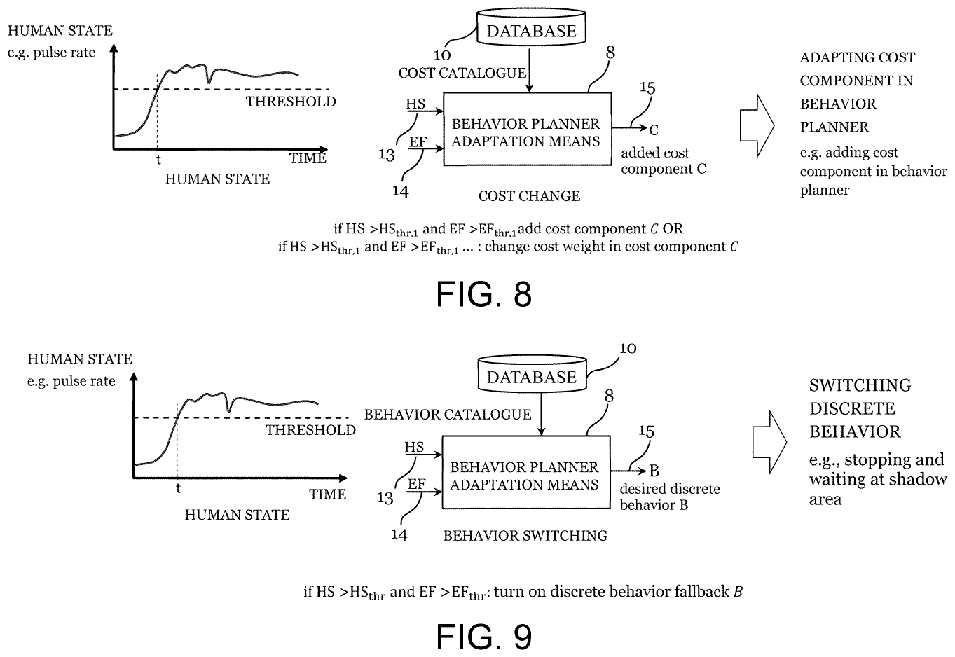

FIG. 8 illustrates the processing in the behavior planner 19 in a first example.

The system 100 determines the user state 13 based on information on a physical condition of the user 20, e.g. using sensor information including a sensed pulse rate acquired by a smart watch worn by the user 20. The external factor determining means 6 then accesses and searches the database 7 based on the determined user state 13, and determines at least one associated external factor 14. The behavior planner adaptation means 8 searches the database 10 using the determined user state 13, e.g. using the pulse rate, and the external factor 14, e.g., a list of external factors including a speed of the user 20, a past curve for user 20, shadow areas in the environment, and road surface characteristics, for example, for determining an adaptation of the total cost used in the behavior planner 9. Adapting the total cost in the behavior planner may include added cost components to the total cost acquired from the database 10 based on the user state 13, the external factor(s) 14, and the list of cost stored in the database 10 associated with respective user state 13 and external factor(s) 14.

The database 10 stores a plurality of cost components associated with user state 13 and external factors 14.

The left portion of FIG. 8 illustrates that the system 100 determines at time t that the determined user state 13 exceeds a threshold level. The system 100, in particular the behavior planner adaptation means 8 then evaluates

$$if HS > {HS}_{thr , 1} and EF > {EF}_{thr , 1} \qquad ( 3 )$$

then add a cost component C to the total cost in the behavior planner, if expression (3) is true. In expression (3), HS denotes the user state 13 and HSthr,1 denotes a threshold value for the user state 13. EF denotes the external factor 14 and EFthr,1 denotes a threshold value for the external factor 14. Alternatively, or additionally, when expression (3) is true, the behavior planner adaptation means 8 then amends the current weight of the cost component C.

The core behavior planner 9 of the improved behavior planner 19 then plans the behavior 16 of the mobile robot 1 using the adapted total cost including at least one of the added cost component C and the amended cost weight in the cost component C

FIG. 9 illustrates the processing in the behavior planner 19, in particular in the behavior planner adaptation means 8 in a second example.

The database 10 stores a plurality of behaviors for the mobile robot 1 associated with user states 13 and external factors 14.

The left portion of FIG. 9 illustrates that the system 100 determines at time t that the determined user state 13 exceeds a threshold level. The system 100, in particular the behavior planner adaptation means 8 then evaluates expression (4)

$$if HS > {HS}_{thr , 1} and EF > {EF}_{thr , 1} \qquad ( 4 )$$

then activates a discrete behavior B in the behavior planner 19, if expression (4) is true. In expression (3), HS denotes the user state 13 and HSthr,1 denotes a threshold value for the user state 13. EF denotes the external factor 14 and EFthr,1 denotes a threshold value for the external factor 14. The behavior planner adaptation means 8 then provides the activated discrete behavior (fallback behavior B) to the behavior planner 19. The core behavior planner 9 of the improved behavior planner 19 then plans the behavior 16 of the mobile robot 1 taking also the activated discrete behavior B into account.

FIG. 10 presents an overview on a high level of abstraction of a hardware architecture suitable for an implementation of the system 100.

The system 100 for controlling the mobile robot 1 that is configured for accompanying a human user 20 depicted in FIG. 10 is implemented using hardware resources of the mobile robot 1, at least one sensor 49 arranged detached from the mobile robot 1, and a remote server 50. A communication network 40 provides a communication between the separate components of the system 100 including the mobile robot 1, the at least one sensor 49, and the remote server 50.

The at least one sensor 49 may include a wearable device, e.g., a smartwatch worn by the user 20.

The server 50 may provide a data storage capacity for storing data of the first and second databases 7, 10. Additionally, or alternatively, the memory 43 of the mobile robot 1 may store the databases 7, 10 discussed with reference to the functional block diagram of FIG. 2.

The mobile robot 1 comprises at least one processor 42 and the memory 43. The processor 42 provides the hardware for running software, in particular a plurality of software modules implementing the acquisition means for acquiring information on the user, the prediction means 12, the a user information acquisition means for acquiring information on the physiological condition of the user 20, the user state determining means 13, the external factor determining means 6, the improved behavior planner 19 including the core behavior planner 9 and the behavior planner adaptation means 8.

The mobile robot 1 comprises at least one sensor 45, e.g. a camera sensor 45 monitoring the environment of the mobile robot 1. The at least one sensor 45 may provide the information acquired by the acquisition means for acquiring information on the user 20, and the user information acquisition means for acquiring information on the physiological condition of the user.

Alternatively and additionally, the information acquired by the acquisition means for acquiring information on the user 20, and the user information acquisition means for acquiring information on the physiological condition of the user running on the processor 42 acquire the respective information using the communication means 41 of the mobile robot 1 via the communication network 40 from the at least one external sensor 49.

The mobile robot 1 further comprises a human machine interface 46, which corresponds to the human machine interface 5 discussed with reference to FIG. 2 and performs the corresponding functions.

The mobile robot 1 further comprises a controller 47, which corresponds to the controller 4 discussed with reference to FIG. 2 and performs the corresponding functions, in particular performing motion control of the mobile robot 1. In particular, the controller 47 controls actors 48 of the mobile robot 1.

The actors 48 of the robot may include wheels, tracks, or legs of a humanoid robot driven by electric motors.

The mobile robot 1 may also include robotic arms with end-effectors as actors 48 controlled by the controller 47. The controller 47 may control the robotic arms for giving pointing directions to the user 20, removing obstacles from a planned movement path of the mobile robot 1 and the user 20, and giving directions to the user 20 accompanied by the mobile robot 1 using pointing gestures.

The communication interface 41 provides the mobile robot 1 with a communication capability via the communication network 40. The communication network may provide communication preferably via wireless communication.

The mobile robot of FIG. 10 comprises a communication bus 44 for connecting the individual components of the mobile robot 1 with each other.

All steps which are performed by the various entities described in the present disclosure as well as the functionalities described to be performed by the various entities are intended to mean that the respective entity is adapted to or configured to perform the respective steps and functionalities.

In the claims as well as in the description the word “comprising” does not exclude the presence of other elements or steps. The indefinite article “a” or “an” does not exclude a plurality.

A single element or other unit may fulfill the functions of several entities or items recited in the claims. The mere fact that different dependent claims recite certain measures and features of the control circuit does not exclude that a combination of these measures and features cannot be combined in an advantageous implementation.

1. A computer-implemented method for controlling a mobile robot accompanying at least one user, wherein the method comprises:
acquiring information on the at least one user;
predicting a motion intention of the at least one user based on the acquired information on the at least one user;
acquiring information on a physiological condition of the at least one user and determining a user state based on the acquired information on the physiological condition;
determining at least one external factor affecting the determined user state;
planning a behavior of the mobile robot that maximizes a user comfort measure determined based on the determined user state and the determined at least one external factor; and
generating a control signal for controlling the mobile robot that implements the planned behavior, and controlling the mobile robot based on the generated control signal.

2. The computer-implemented method according to claim 1, wherein
the information on the physiological condition includes information on at least one of a pulse rate, heart rate, blood oxygen level, blood pressure and body temperature of the at least one user.

3. The computer-implemented method according to claim 1, wherein
determining the user state is further based on image information of a face of the at least one user, or image information of a body shape of the at least one user.

4. The computer-implemented method according to claim 1, wherein
the information on the physiological condition of the at least one user for determining the user state includes acquired sensor information from at least one sensor of the mobile robot,
in particular from a camera sensor capturing image information depicting the at least one user.

5. The computer-implemented method according to claim 1, wherein the at least one external factor includes at least one of
a crowd density, a walking duration, a walking distance, a spatial concentration of a group of users, an ambient temperature, a shadow area in the environment, a sunlit area in the environment, a speed, a number and layout of curves along a movement path.

6. The computer-implemented method according to claim 1, wherein determining the external factor includes at least one of
sensing, by a film capacity rain sensor or by a camera sensor, rainfall or snowfall,
sensing, by a temperature sensor, an ambient temperature,
determining, by the camera sensor, sunlight intensity, in particular a spatial distribution of sunlight intensity in the environment of the mobile robot,
sensing, by a light sensor, glaring light,
sensing, by a wind sensor, at least one of a wind direction and wind strength,
capturing, by the camera sensor, an image of a surface, and performing, by a processor, image processing on the captured images for determining at least one of a stony surface, rocky surface, a wet surface, a dirty road surface, and a road slope,
acquiring, from a database stored on a server, at least one of congestion information, a number of visitors for a shop or museum, a waiting time, and
acquiring, by a communication interface of the mobile robot, sensor information for determining the at least one external factor.

7. The computer-implemented method according to claim 1, wherein
predicting the motion intention of the at least one user includes predicting a user trajectory with a constant velocity model based on the acquired information on the at least one user.

8. The computer-implemented method according to claim 1, wherein
planning the behavior of the mobile robot includes planning a trajectory for the mobile robot that guides the at least one user on a movement path different from an intended movement path of the predicted motion intention of the at least one user, in case the user comfort measure of the planned trajectory exceeds the user comfort measure of the intended movement path of the predicted motion intention of the at least one user, or
planning the trajectory of the mobile robot that guides the at least one user on the intended movement path of the predicted motion intention of the at least one user in case the user comfort measure of the planned trajectory does not exceed the comfort measure of the intended movement trajectory of the predicted motion intention of the at least one user.

9. The computer-implemented method according to claim 1, wherein planning the behavior of the mobile robot comprises
determining a discomfort measure based on the determined user state and the at least one external factor, and in case of the determined discomfort measure exceeding a threshold, and
adapting parameters in a behavior planner according to the determined user state, the predicted motion intention of the at least one user, and the at least one external factor.

10. The computer-implemented method according to claim 9, wherein adapting the parameters of the behavior planner includes at least one of
adapting cost components in a total cost term used in the behavior planner,
adding behavior options of the mobile robot, and
adapting weights of the cost components used in the behavior planner.

11. The computer-implemented method according to claim 1, wherein planning the behavior of the mobile robot comprises
planning the behavior by a cost-based planner, in particular a cooperative risk maps planner, or
a search-based planner in particular a A* or Monte Carlo tree search based planner, or
a sampling-based planner in particular a RRT based or probabilistic roadmap-based planner, or
a reinforcement learning in particular a Q-learning-based or PPO-based planner.

12. The computer-implemented method according to claim 1, wherein controlling the mobile robot based on the generated control signal includes at least one of
controlling, by a controller, movement of the mobile robot, and
generating output information based on the planned behavior and outputting the generated output information by a human machine interface of the mobile robot.

13. A system for controlling a mobile robot configured for accompanying at least one user, wherein the system comprises:
a hardware processor configured to:
acquire information on the at least one user;
predict a motion intention of the at least one user based on the acquired information on the at least one user;
acquire information on a physiological condition of the at least one user;
determine a user state based on the acquired information on the physiological condition;
determine at least one external factor affecting the determined user state;
plan a behavior of the mobile robot that maximizes a user comfort measure determined based on the determined user state and the determined at least one external factor; and
at least one of
a controller configured to generate a control signal that implements the planned behavior and control actors of the mobile robot based on the generated control signal, and
a human machine interface configured to generate output information based on the planned behavior of the mobile robot and output the generated output information to the at least one user.
